(19) United States
(12) Patent Application Publication
(10) Pub. No.: US 2014/0022612 A1
(43) Pub. Date: Jan. 23, 2014

(54) IMAGE READING APPARATUS

(71) Applicant: CANON KABUSHIKI KAISHA, Tokyo (JP)

(72) Inventors: Mitsuyuki Fujibayashi, Kawasaki-shi (JP); Takashi Awai, Chiba-shi (JP)

(21) Appl. No.: 13/906,863

(22) Filed: May 31, 2013

(30) Foreign Application Priority Data
Jul. 20, 2012 (JP) 2012-161962

(51) Int. Cl. H04N 1/10

(52) U.S. Cl. CPC H04N 1/1008
USPC 358/496

(57) ABSTRACT

An image reading apparatus comprises a reading unit including a sensor; a driving unit configured to move the reading unit to read an original placed on a platen; a feed unit configured to feed the original to move and read the original with respect to the reading unit being at rest in a predetermined position; a transfer unit configured to transfer a driving force of the driving unit to the feed unit while the reading unit is at rest in the predetermined position; and a switching unit configured to permit or restrict movement of the reading unit from the predetermined position.

### BACKGROUND OF THE INVENTION

1. Field of the Invention

The present invention relates to an image reading apparatus.

2. Description of the Related Art

As an original reading apparatus such as a copying machine, an original reading apparatus which can select two original reading modes has been known. The first original reading mode is stationary original reading by a flatbed scanner (FBS) which reads an original, placed on an original platen, while moving a reading sensor disposed below the original. The second original reading mode is fed original reading in which an original is read upon being automatically fed by an auto document feeder (ADF) in the state where a reading sensor is at rest in a predetermined position.

An original reading apparatus of this type includes a main body unit, and an opening/closing unit rotatably supported by the main body unit. The main body unit includes an original platen and reading sensor. The opening/closing unit includes a pressure plate and ADF, and opens/closes the original platen. US2008-0266614 discloses an apparatus equipped with a transfer unit which transfers the driving force of a driving source, provided in a main body unit, to the ADF in order to reduce the number of driving sources unique to the ADF and to keep the apparatus cost low.

In US2008-0266614, a flatbed scanner and a sheet-through scanner are operated by a common driving source. However, a mechanism used for this operation is complex, so it is difficult to reduce the manufacturing cost and downsize the apparatus.

### SUMMARY OF THE INVENTION

The present invention has been made in consideration of the aforementioned problems, and realizes a convenient image reading apparatus, which has the functions of both a sheet-through scanner and flatbed scanner capable of reading various types of originals, at a low cost without a large number of driving sources.

In order to solve the aforementioned problems, the present invention provides an image reading apparatus comprising: a reading unit including a sensor; a driving unit configured to move the reading unit to read an original placed on a platen; a feed unit configured to feed the original to move and read the original with respect to the reading unit being at rest in a predetermined position; a transfer unit configured to transfer a driving force of the driving unit to the feed unit while the reading unit is at rest in the predetermined position; and a switching unit configured to permit or restrict movement of the reading unit from the predetermined position.

In order to solve the aforementioned problems, the present invention provides an image reading apparatus comprising: a reading unit including a sensor; a driving unit which is configured to move the reading unit to read an original placed on a platen, and includes a driving source mounted on the reading unit; a feed unit configured to feed the original to move and read the original with respect to the reading unit being at rest in a predetermined position; and a transfer unit configured to transfer a driving force of the driving unit to the feed unit while the reading unit is at rest in the predetermined position.

According to the present invention, it is possible to realize a convenient image reading apparatus, which has the functions of both a sheet-through scanner and flatbed scanner capable of reading various types of originals, at a low cost without a large number of driving sources.

Further features of the present invention will become apparent from the following description of exemplary embodiments with reference to the attached drawings.

### BRIEF DESCRIPTION OF THE DRAWINGS

FIG. 1 is an external view of an image reading apparatus in this embodiment;

FIG. 2 is an external view of the image reading apparatus while its cover is open in this embodiment;

FIG. 3 is an external view of a flatbed scanner in the image reading apparatus of this embodiment;

FIG. 4 is an external view of the flatbed scanner in the image reading apparatus of this embodiment;

FIG. 5 is an external view of an image reading unit in this embodiment;

FIGS. 6A to 6D are external views of a switching mechanism for the image reading unit in this embodiment;

FIGS. 7A to 7C are external views of the switching mechanism for the image reading unit in this embodiment;

FIGS. 8A to 8D are views for explaining the operation of the switching mechanism in this embodiment;

FIGS. 9A to 9L are views for explaining a switching operation in this embodiment; and

FIG. 10 is a sectional view showing the positional relationship between the image reading unit and the switching mechanism in this embodiment.

### DESCRIPTION OF THE EMBODIMENTS

A mode for carrying out the present invention will be described in detail hereinafter. Note that an embodiment to be described hereinafter is an example required to implement the present invention and should be modified or changed as needed depending on configurations of apparatus and various conditions to which the present invention is applied, and the present invention is not limited to the following embodiment. Some of embodiments to be described later may be combined as needed.

[First Embodiment]

An embodiment in which an image reading apparatus according to the present invention is built into an image output apparatus such as a printer will be described below.

<Apparatus Configuration>

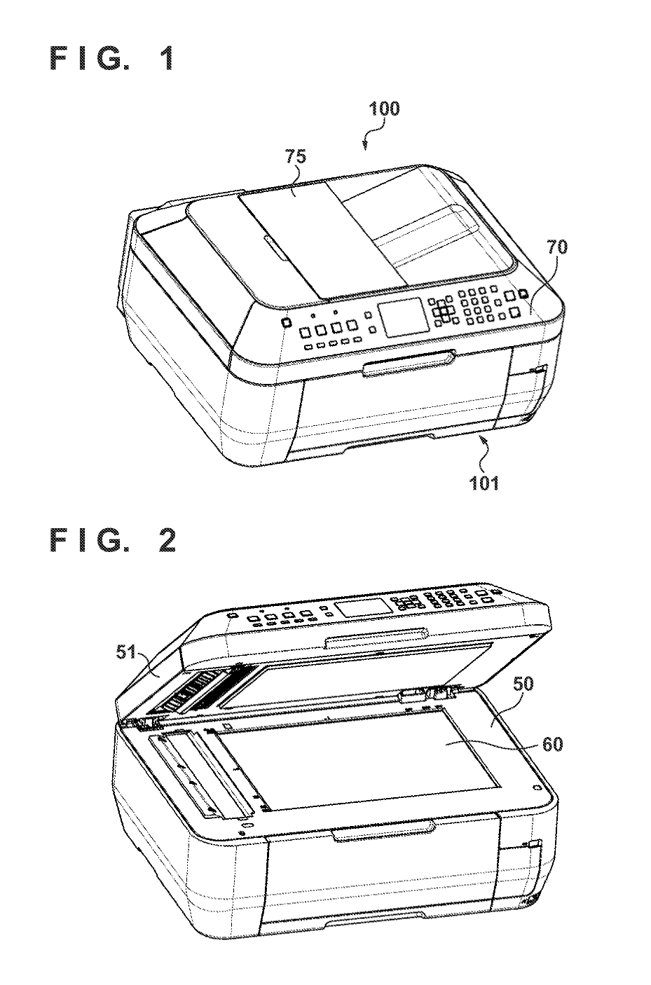

The outline of the configuration and function of an image reading apparatus in an embodiment according to the present invention will be described with reference to FIGS. 1 and 2. Although a multifunction peripheral which combines an image output apparatus 101 and an image reading apparatus 100 has been exemplified in this embodiment, the present invention can also be practiced independently by the image reading apparatus 100.

Reference numeral 50 denotes a flatbed scanner (to be abbreviated as an FBS hereinafter) which holds an original stationary and obtains image data, and serves as an image reading unit compatible with, for example, a book original and a large-sized original. Reference numeral 51 denotes an original feed unit (also called an ADF) which mounts a plurality of standard-sized documents and separates and feeds them one by one, and functions as a sheet-through scanner (to be abbreviated as an STS hereinafter) in combination with part of the FBS 50. The STS includes an original reversing mechanism which allows double-sided reading of an original.

Referring to FIGS. 1 and 2, when the user operates the FBS 50, first, an original is placed on an original mount surface 60 serving as an original platen while the original feed unit 51 is open (FIG. 2), and the original feed unit 51 is then closed (FIG. 1). An image read command is sent to the apparatus 100 from an operation unit 70 or an external device (not shown) connected by the wireless or wired system, and reading of image data is completed. Note that as in this embodiment, when the image reading apparatus 100 and image output apparatus 101 are built in combination, the read image data can be printed by the image output apparatus 101 to create a duplicate document for the original document.

When the user uses the STS, first, a duplicate document mount table 75 is opened to place an original on it. An image read command is sent to the apparatus 100 from the operation unit 70 or an external device (not shown) connected by the wireless or wired system, and reading of image data is completed. In this case as well, the apparatus 100 may create a duplicate document for the original document in the same manner as above.

<Configuration of Flatbed Scanner>

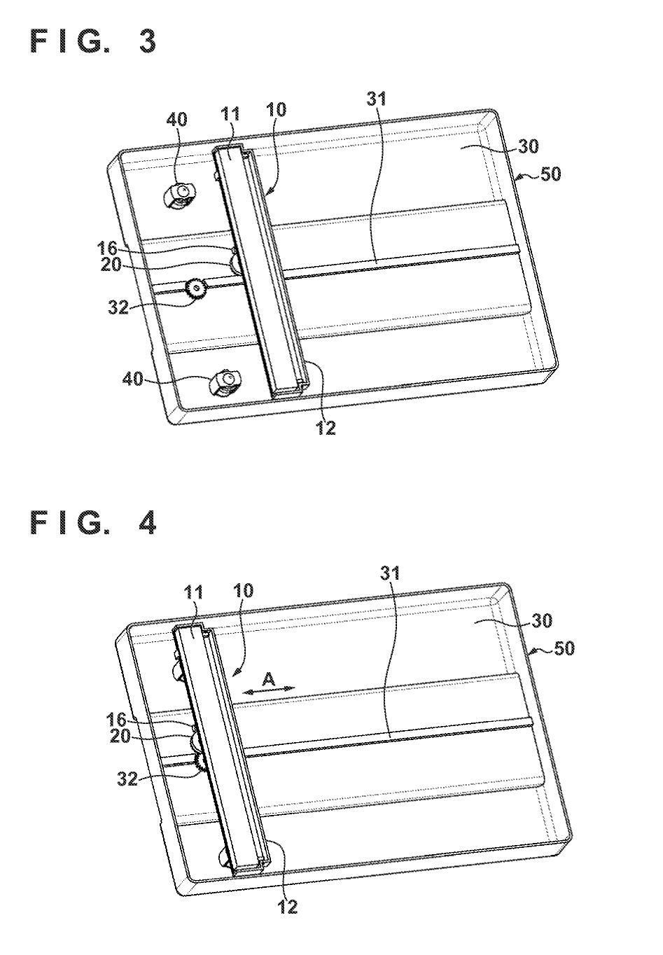

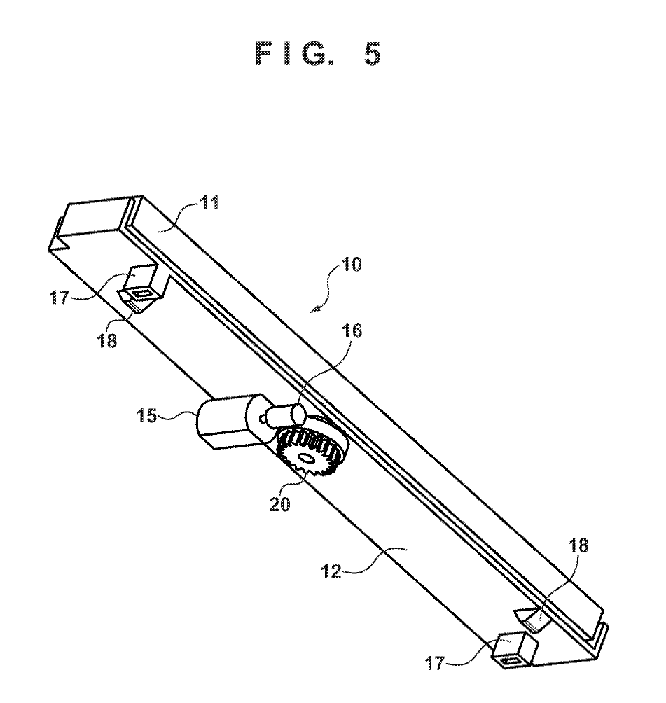

The configuration of the FBS 50 built into the image reading apparatus 100 in this embodiment will be described with reference to FIGS. 3 to 5.

Referring to FIGS. 3 and 4, an image reading unit 10 includes a reading sensor 11 which irradiates an original with light, forms an image of the light reflected by the original, and converts it into an electrical signal. The reading sensor 11 serves as a line sensor (image sensor). The image reading unit 10 also includes a driving source 15 such as a motor, and a two-stage gear 20 which meshes with a worm gear 16 fixed to the output shaft of the driving source 15. The image reading unit 10 moreover includes a holder 12 which holds the reading sensor 11, driving source 15, and two-stage gear 20. Projections 17 and 18 are attached to each of the two ends of the holder 12 in the longitudinal direction. The projection 17 has a box shape, while the projection 18 has a convex shape, and their functions will be described later.

Reference numeral 30 denotes an image reading dark box (to be simply referred to as a dark box hereinafter) with a recessed cross-section, in which a rack 31 that meshes with a gear, that does not mesh with the worm gear 16, of the two-stage gear 20 is formed. In such a configuration, first, when power is supplied to the driving source 15 via a wiring line (not shown), the worm gear 16 attached to the driving source 15 is rotated to rotate the two-stage gear 20 that meshes with it. Further, since the two-stage gear 20 meshes with the rack 31 formed in the dark box 30, the image reading unit 10 reciprocally moves in directions A within the dark box 30.

FIG. 3 shows the state where the image reading unit 10 is moved to the image reading region of the FBS 50. A transfer gear 32 is disposed in the portion where the rack 31 is partially cut away. As the pitch circle of the transfer gear 32 is set on the pitch line of the rack 31 in a contact state, the meshing portion of the gear, that meshes with the rack 31, of the gears of the two-stage gear 20 can be moved to the transfer gear 32 in a series of operations shown in FIGS. 3 and 4.

Note that the transfer gear 32 meshes with a driving gear train (not shown), and transfers a driving force to the original feed unit 51 to allow original feed.

FIG. 4 shows the state where the image reading unit 10 is moved to the image reading position of the STS. In the case of the STS, in the state where the image reading unit 10 is at rest, an image is read while an original document is transferred by the original feed unit 51. In the case of the FBS 50, the original placed on the original mount surface 60 is read while the image reading unit 10 is moved in the directions A.

The movement of the image reading unit 10 is restricted or permitted by a pair of switching mechanisms 40 provided at positions corresponding to its two ends in the longitudinal direction. The switching mechanisms 40 are fixed to the bottom surface of the dark box 30.

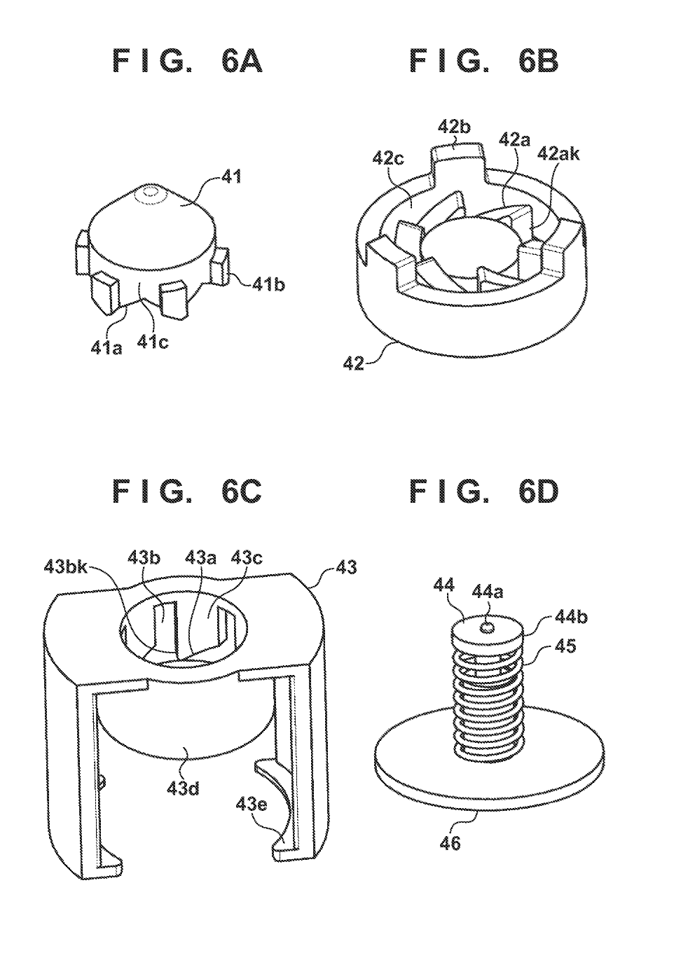

FIGS. 6A to 6D show the practical configuration of the switching mechanism 40. The switching mechanism 40 includes a switch member 41, rotor 42, stator 43, and pressing member 44.

As shown in FIG. 6A, the switch member 41 has a shape similar to a combination of a cylindrical surface and a conical surface, and an isosceles triangular cam surface 41a is formed at the lower end of a cylinder portion 41c to have a pitch of 60°. Also, projections 41b are similarly formed in the cylinder portion 41c to have a pitch of 60°.

As shown in FIG. 6B, a right-angled triangular cam surface 42a is formed in the hollow cylindrical structure of the rotor 42 to have a pitch of 60° in the circumferential direction. Also, projections 42b are formed on the rotor 42 at 120° intervals.

As shown in FIG. 6C, a cam surface 43a and slits 43b are formed in the hollow cylindrical structure of the stator 43 to have a pitch of 60° in the circumferential direction. Also, the cam surface 43a forms a cylinder inner surface 43c of the stator 43. Moreover, a latching portion 43e is formed on a cylinder outer surface 43d of the stator 43.

As shown in FIG. 6D, the pressing member 44 includes a spring 45 which presses the rotor 42, a flange portion 44b which holds one end of the spring 45, and a stopper 46 which holds the other end of the spring 45. The flange portion 44b is provided with a projecting portion 44a. The stopper 46 is latched to the latching portion 43e of the stator 43, and guides the pressing member 44 in the direction to press the spring 45.

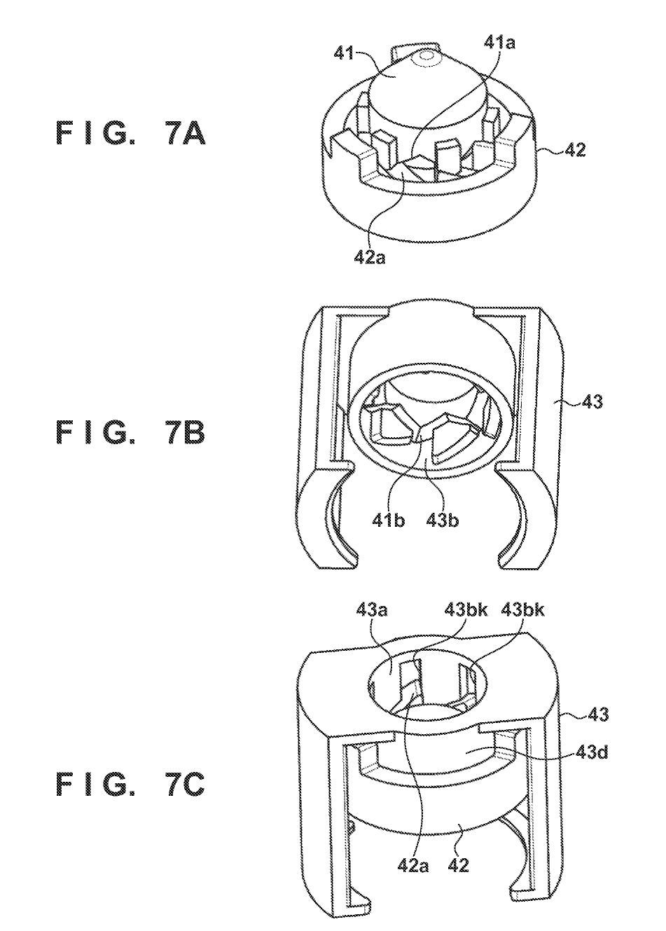

FIGS. 7A to 7C show a structure formed by a combination of the switch member 41, rotor 42, stator 43, and pressing member 44 shown in FIGS. 6A to 6D.

As shown in FIG. 7A, the cam surface 41a of the switch member 41 is in contact with the cam surface 42a of the rotor 42. Also, as shown in FIG. 7B, the projection 41b of the switch member 41 engages with the slit 43b of the stator 43. In the switch member 41, the cylinder portion 41c is coaxially supported by the cylinder inner surface 43c of the stator 43. Moreover, as shown in FIG. 7C, the cam surface 42a of the rotor 42 is in contact with the cam surface 43a of the stator 43. A cylinder inner surface 42c of the rotor 42 is coaxially guided and rotatably supported by the cylinder outer surface 43d of the stator 43.

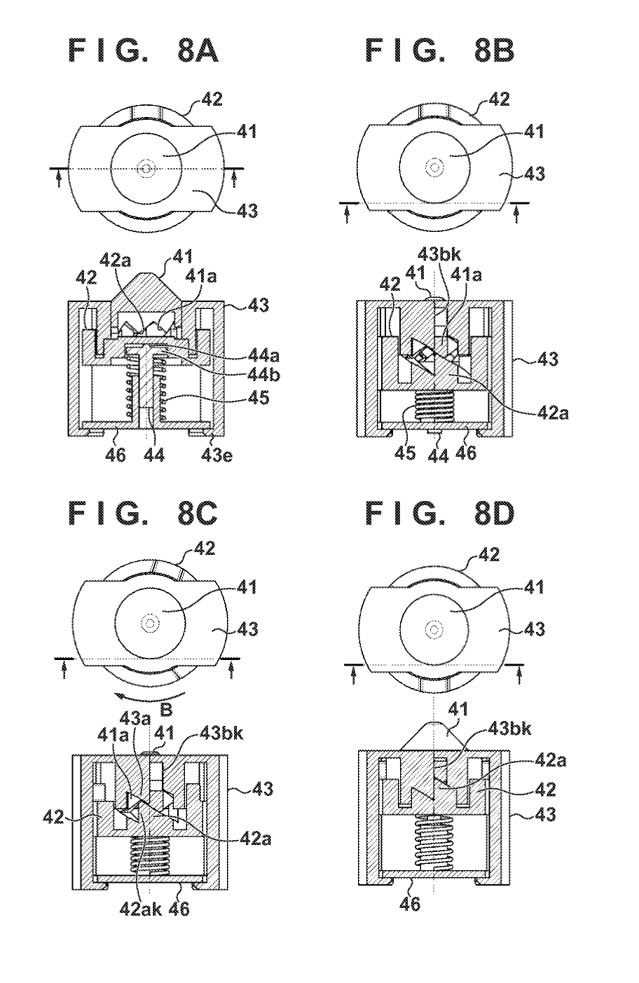

The operation of the switching mechanism 40 will be described with reference to FIGS. 8A to 8D.

Referring to FIG. 8A, when the spring 45 presses the flange portion 44b of the pressing member 44 upwards, the projecting portion 44a of the pressing member 44 presses the bottom portion of the center of the rotor 42 to lift the rotor 42. Further, the cam surface 42a of the rotor 42 pushes up the cam surface 41a of the switch member 41 to, in turn, push up the switch member 41.

The pressed rotor 42 stops as the cam surface 42a comes into contact with the cam surface 43a of the stator 43 and one wall 43bk of the slit 43b (FIG. 7C). Also, the switch member 41 stops as the cam surface 41a comes into contact with the cam surface 42a of the rotor 42 (FIG. 7A). Note that in this state, the stopper 46 is biased downwards by the spring 45, but is suspended as it comes into contact with the latching portion 43e of the stator 43.

Referring to FIG. 8B, as the switch member 41 is more deeply pressed downwards against the spring 45, the cam surface 41a presses the cam surface 42a of the rotor 42, and further pushes down the flange portion 44b of the pressing member 44, so the spring 45 compresses to reduce the distance between the flange portion 44b and the stopper 46.

Referring to FIG. 8C, the rotor 42 releases restriction in the rotation direction about the axis by contact between a vertical wall 42ak of the cam surface 42a, and the wall 43bk of the slit 43b of the stator 43. With this operation, the rotor 42 spirally rotates as the cam surface 42a comes into contact with the cam surface 43a of the stator 43. That is, when the switch member 41 is pressed down to a given position, engagement between the rotor 42 and the stator 43 in the rotation direction about the axis by contact between the cam surfaces 42a and 43a is released to rotate the rotor 42 in a direction B. Note that as shown in a sectional view of FIG. 8C, this rotation operation is performed so that upon ascent of the switch member 41, the tip of the vertical wall 42ak of the cam surface 42a of the rotor 42, and the tip of the cam surface 41a coincide with the intersection point between the cam surface 41a of the switch member 41 and the cam surface 43a of the stator 43.

Referring to FIG. 8D, when the switch member 41 returns to the original position by the spring 45, the rotor 42 rotates through a predetermined angle, so the next cam surface 60° out of phase with the previous cam surface 42a stops on the wall 43bk.

Note that referring to FIG. 8C, the switching mechanism 40 does not rotate even when the rotor 42 is rotated in the direction B from the outside, while it spirally rotates when the rotor 42 is rotated in a direction opposite to the direction B.

As described above, when the switching mechanism 40 performs one vertical reciprocal moving operation of the switch member 41, the rotor 42 rotates through 60° in one direction so that the projections 42b formed on the rotor 42 at 120° intervals enter/exit the stator 43.

<Switching Operation>

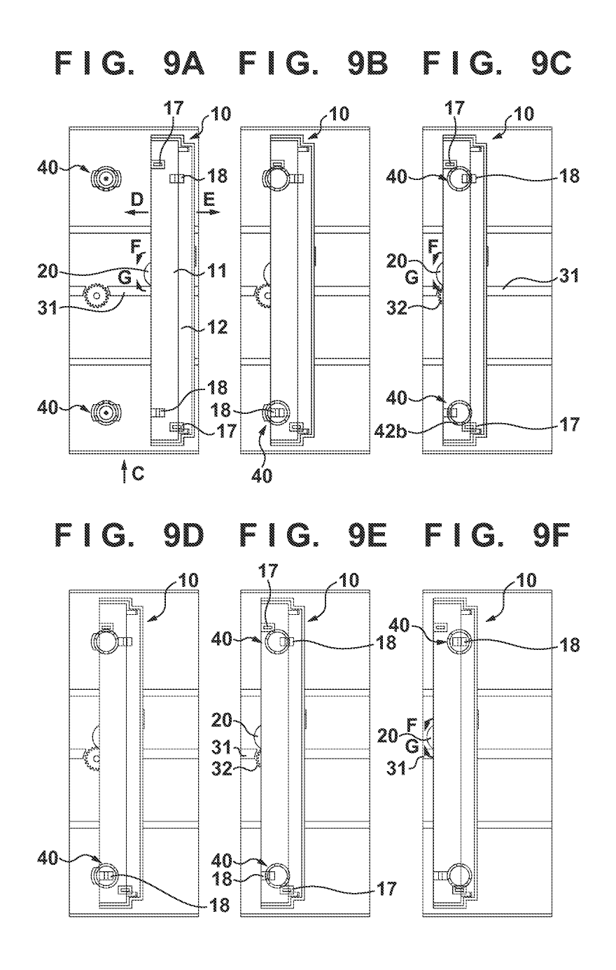

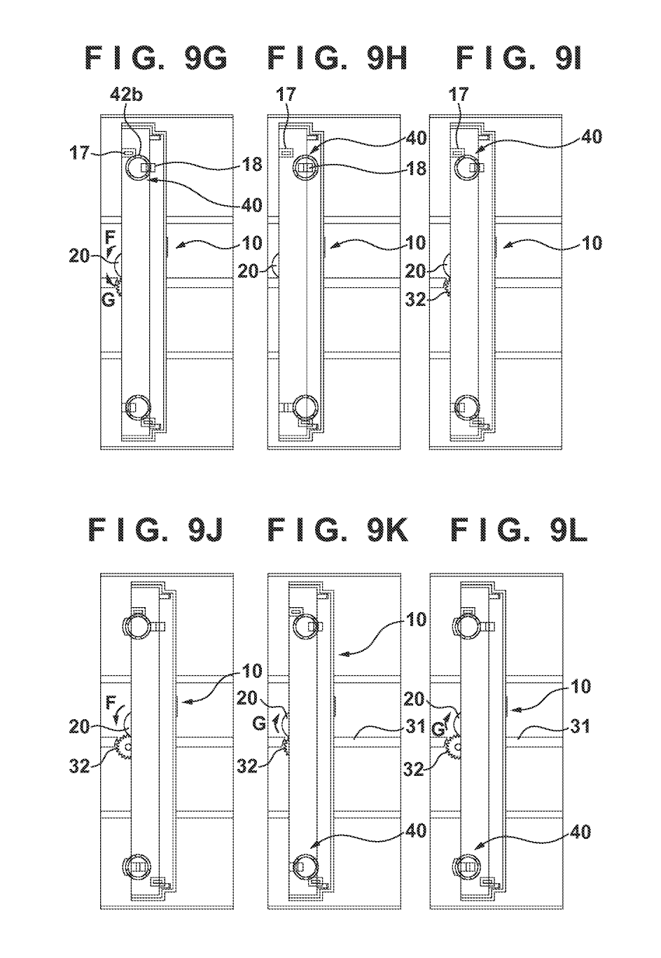

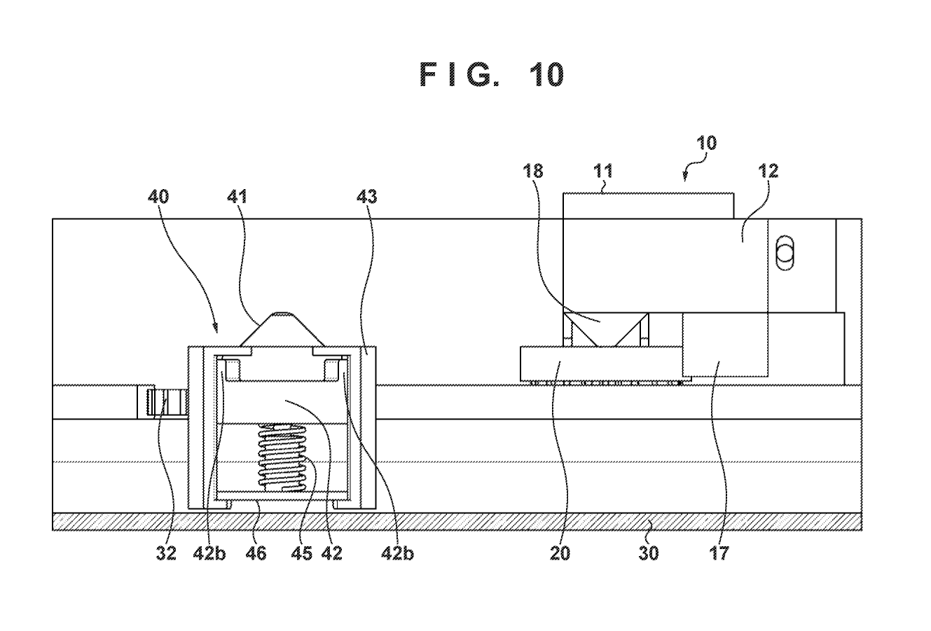

An operation of permitting or restricting(suspending) the movement of the image reading unit 10 by the switching mechanism 40 will be described next with reference to FIGS. 9A to 10.

FIGS. 9A to 9L show the FBS 50, shown in FIGS. 3 and 4, as viewed from above. Also, FIG. 10 is a partial sectional view of the image reading unit 10, shown in FIG. 9A, as viewed from a direction C.

Referring to FIG. 10, the image reading unit 10 is horizontally movable in FIG. 10. Upon movement of the image reading unit 10, the projections 17 and 18 formed at the bottom of the holder 12 also move. The projection 17 forms a positional relationship in which it engages with the projection 42b of the rotor 42 of the switching mechanism 40 in the vertical direction of FIG. 10. Similarly, the projection 18 forms a positional relationship in which it engages with the conical surface of the switch member 41.

Also, as shown in FIGS. 9A to 9L, the pair of switching mechanisms 40 are vertically separated in FIGS. 9A to 9L. In the switching mechanism 40, the projection 18 is formed at the position where it engages with the switch member 41, and the projection 17 is formed at the position where it engages with the rotor 42, in the vertical direction of FIGS. 9A to 9L.

With this arrangement, when the image reading unit 10 moves in a direction D of FIG. 9A, the switching mechanisms 40 can be actuated. Note that referring to FIGS. 9A to 9L, the switching mechanisms 40 and projections 17 and 18 are often hidden at positions below the image reading unit 10, but they are indicated by solid lines for the sake of convenience.

A switching operation by the switching mechanism 40 according to this embodiment will be described herein with reference to FIGS. 9A to 9L.

Referring to FIG. 9A, the image reading unit 10 is at a standby position, and the image reading region of the FBS extends in a direction E to perform an image reading operation on the FBS side by reciprocal movement in the direction E from the standby position of the image reading unit 10.

The image reading position (predetermined position) of the STS extends in the direction D. The image reading unit 10 is at rest in the image reading position of the STS, and image reading is done by the STS while the image reading unit 10 rests at this position.

In the image reading operation of the STS, first, when the apparatus is notified of an image read command of the STS, power is supplied to the driving source 15 of the image reading unit 10 to rotate the two-stage gear 20 in a direction F. Upon the rotation of the two-stage gear 20, the image reading unit 10 starts to move in the direction D from the standby position along the rack 31 with which the two-stage gear 20 meshes.

Referring to FIG. 9B, when the image reading unit 10 moves to a position shown in FIG. 9B, the switch member 41 of the switching mechanism 40 engages with the projection 18 to push down the switch member 41.

Referring to FIG. 9C, when the image reading unit 10 further moves in the direction D, the amount of push-down of the projection 18 reduces, so the switch member 41 of the switching mechanism 40 ascends. With this vertical moving operation, the switch member 41 performs one vertical reciprocal moving operation in FIG. 10, so the rotor 42 rotates through 60° from the state shown in FIG. 9A. At this time, the projection 42b of the rotor 42 forms a positional relationship in which it engages with the projection 17 of the image reading unit 10 in the vertical direction of FIGS. 9A to 9F, so they come into contact with each other to restrict (suspend) the image reading unit 10, which is about to move in the direction D. In this restricted (suspended) state (rest state), the two-stage gear 20 of the image reading unit 10 meshes with the transfer gear 32 of the rack 31. When the driving source 15 further rotates the two-stage gear 20 in the direction F, the transfer gear 32 rotates to transfer a driving force to the original feed unit 51 by a gear train connected to the transfer gear 32. Note that at the positions of the image reading unit 10 shown in FIGS. 9A to 9C, the switching mechanism 40 and projections 17 and 18 on the upper sides of FIGS. 9A to 9C remain the same without interacting with each other.

Note that when the driving source 15 rotates in the opposite direction to rotate the transfer gear 32 in a direction G, the image reading unit 10 moves to the standby position shown in FIG. 9A. When the image reading unit 10 completes its return operation to the standby position, the switching mechanism 40 and projection 18 on the lower side of FIG. 9A interact with each other by an operation opposite to the above case, so the rotor 42 rotates through 60° to obtain a state shown in FIG. 9A. If a driving force to be transferred to the original feed unit 51 is required for rotation in only one direction, that is, if the original is fed in only one direction, a series of operations shown in FIGS. 9A to 9C is repeated.

An operation when a driving force to be transferred to the original feed unit 51 is required for rotation in the two directions will be described next.

First, referring to FIG. 9A, the image reading unit 10 is moved from the standby position to the position shown in FIG. 9C. That is, the image reading unit 10 is moved so that the switching mechanism 40 on the lower side of FIG. 9A operates once (the rotor 42 rotates through) 60°. Then, the driving source 15 is rotated in the opposite direction to rotate the transfer gear 32 in the direction G so that the image reading unit 10 moves in the direction E until the vertex of the convex shape of the projection 18 is positioned at the center of the switch member 41 of the switching mechanism 40 on the lower side of FIG. 9D.

Note that when the driving source 15 is rotated in the reverse direction again to move the image reading unit 10 toward a predetermined driving force transfer position where a driving force is transferred to the original feed unit 51, the switching mechanism 40 on the lower side of FIG. 9D can perform the second operation. Referring to FIG. 9E, the switching mechanism 40 on the lower side of FIG. 9E operates twice from the state shown in FIG. 9A, and the vertex of the convex shape of the projection 18 of the image reading unit 10 is positioned on the left side with respect to the center of the switch member 41 of the switching mechanism 40. At this time, the projection 42b of the rotor 42 of the switching mechanism 40 on the lower side of FIG. 9E, and the projection 17 of the image reading unit 10 form a positional relationship in which they do not engage with each other to permit the movement of the image reading unit 10 in the direction D. With this operation, the two-stage gear 20 meshes with the transfer gear 32, and then meshes with the rack 31 formed on the left side of the transfer gear 32. That is, as shown in FIG. 9F, the image reading unit 10 is positioned on the left side with respect to the driving force transfer position (FIG. 9E) for the original feed unit 51.

Note that to operate the switching mechanism 40 twice so as to move the image reading unit 10 to a position shown in FIG. 9F, not only the above-mentioned operation but also a method of moving the image reading unit 10 from the state shown in FIG. 9A to that shown in FIG. 9B, temporarily returning it to the position shown in FIG. 9A, and moving it to the position shown in FIG. 9E is also available.

Since the projection 18 on the upper side of FIGS. 9A to 9E does not form a positional relationship in which it operates the switching mechanism 40 from the above-mentioned states shown in FIGS. 9A to 9E, the projection 42b of the rotor 42 of the switching mechanism 40 is kept unengaged with the projection 17. Referring to FIG. 9F, the switching mechanism 40 and projection 18 on the upper side of FIG. 9F interact with each other for the first time.

The two-stage gear 20 is rotated in the direction F to move the image reading unit 10 to the position shown in FIG. 9F, and the two-stage gear 20 is rotated in the reverse direction G to move the image reading unit 10 to a position shown in FIG. 9G. In this case, the switching mechanism 40 on the upper side of FIG. 9G operates once to form a positional relationship in which the projection 17 and the projection 42b of the rotor 42 engage with each other. In this state, when the two-stage gear 20 is rotated in the direction G, a rotary driving force in a direction opposite to the above case in FIG. 9C can be transferred to the original feed unit 51.

An operation from the state shown in FIG. 9G until a return to the initial standby position shown in FIG. 9A will be described lastly.

When the two-stage gear 20 is rotated in the direction F from the state shown in FIG. 9G to obtain a state shown in FIG. 9H, and the two-stage gear 20 is rotated in the direction G, the switching mechanism 40 on the upper side of FIG. 9H can operate once. With this operation, the projection 17 and the projection 42b of the rotor 42 on the upper side of FIG. 9H form a positional relationship in which they do not engage with each other, so the image reading unit 10 can be moved from a position shown in FIG. 91 to that shown in FIG. 9J. Referring to FIG. 9J, the two-stage gear 20 of the image reading unit 10 forms again a positional relationship in which it meshes with the right rack 31 of the transfer gear 32. Note that when the two-stage gear 20 is rotated in the direction F to move the image reading unit 10 to a position shown in FIG. 9K, the switching mechanism 40 on the lower side of FIG. 9K operates once. When the two-stage gear 20 is rotated in the direction G again to move the image reading unit 10 to the position shown in FIG. 9A through that shown in FIG. 9L, the switching mechanism 40 on the lower side of FIG. 9A operates once to make a return to the state shown in FIG. 9A.

As described above, according to this embodiment, a pair of switching mechanisms are arranged at the two ends of the image reading unit in the longitudinal direction, and the image reading unit is moved in a predetermined order in a direction perpendicular to the longitudinal direction to allow movement of the image reading region of the FBS in the two directions, and original feed of the STS in the two directions.

Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-161962, filed Jul. 20, 2012, which is hereby incorporated by reference herein in its entirety.

What is claimed is:

1. An image reading apparatus comprising:
a reading unit including a sensor;
a driving unit configured to move said reading unit to read an original placed on a platen;
a feed unit configured to feed the original to move and read the original with respect to said reading unit being at rest in a predetermined position;
a transfer unit configured to transfer a driving force of said driving unit to said feed unit while said reading unit is at rest in the predetermined position; and
a switching unit configured to permit or restrict movement of said reading unit from the predetermined position.

2. The apparatus according to claim 1, wherein a driving source of said driving unit is mounted on said reading unit, and moves together with said reading unit.

3. The apparatus according to claim 1, wherein said switching unit performs switching upon movement of said reading unit.

4. The apparatus according to claim 1, wherein
said switching unit comprises:
a switch member configured to ascend or descend upon movement of said reading unit;
a rotor configured to rotate through a predetermined angle every time said switch member ascends or descends, and contact a projection formed on said reading unit;
a stator configured to rotatably support said rotor; and
a biasing unit configured to bias said switch member and said rotor in one direction,
said reading unit including a pressing portion in which said reading unit engages with said switch member in accordance with a position thereof.

5. The apparatus according to claim 4, wherein
a pair of switching units are disposed on said reading unit, and said pressing portion is formed on said reading unit at a position corresponding to each of said pair of switching units, and
said switching unit performs switching upon movement of said reading unit.

6. The apparatus according to claim 1, wherein said reading unit reads an original moved by said feed unit when said reading unit is at the predetermined position.

7. An image reading apparatus comprising:
a reading unit including a sensor;
a driving unit which is configured to move said reading unit to read an original placed on a platen, and includes a driving source mounted on said reading unit;
a feed unit configured to feed the original to move and read the original with respect to said reading unit being at rest in a predetermined position; and
a transfer unit configured to transfer a driving force of said driving unit to said feed unit while said reading unit is at rest in the predetermined position.

8. The apparatus according to claim 7, further comprising:
a unit configured to restrict movement of said reading unit so that said reading unit rests at the predetermined position even when said driving source is driven.
